(19) United States
(12) Patent Application Publication
(10) Pub. No.: US 2009/0086024 A1
(43) Pub. Date: Apr. 2, 2009

(54) SYSTEM AND METHOD FOR IMPROVING VIDEO COMPRESSION EFFICIENCY

(75) Inventor: Nicholas Shayne Brookins, Grand Blanc, MI (US)

Correspondence Address: HARNESS, DICKEY & PIERCE, P.L.C., P.O. BOX 828, BLOOMFIELD HILLS, MI, 48303, US

(73) Assignee: SAM SYSTEMS, INC., Sterling Heights, MI (US)

(21) Appl. No.: 12/244,169

(22) Filed: Oct. 2, 2008

Related U.S. Application Data
(60) Provisional application No. 60/997,387, filed on Oct. 2, 2007.

(51) Int. Cl. H04N 7/18; H04N 5/228

(52) U.S. Cl. 348/143; 348/222.1; 348/E05.031; 348/E07.085

(57) ABSTRACT

A system and method for improving the efficiency of video compression is based on the characteristics of the video to be stored. Operating characteristics of the video capture device, as well as content characteristics of the video signal to be compressed, are utilized to control various processes that manipulate the video signal to maintain areas of interest in high quality, while lowering the amount of processing and storage dedicated to areas of low interest. The processes and encoding methods may also be adjusted based on these operating characteristics and content characteristics, as well as inputs from additional sensors or devices.

### CROSS-REFERENCE TO RELATED APPLICATIONS

This application claims the benefit of U.S. Provisional Application No. 60/997,387, filed on Oct. 2, 2007. The entire disclosure of the above application is incorporated herein by reference.

### FIELD

The present disclosure relates to video processing and, more particularly, to a system and method for improving video quality, processing effectiveness and video compression efficiency.

### BACKGROUND

This section provides background information related to the present disclosure which is not necessarily prior art.

In typical video systems, the source video captured by the video capturing device is not of the highest quality. For example, in surveillance video there may be a graininess from low lighting or weather conditions, shakiness from camera instability and/or signal loss from cabling. Additionally, limitations from the video capture device, as well as dirty lenses, may result in video that is of a relatively low quality. The issues identified above may introduce defects in the video signal, which detract from the content of interest to a user.

The defects identified above also present a problem when the raw video signal is translated or encoded into a storage or transport format. Some video systems limit the amount of data that can be stored and, therefore, ignore portions of the video signal deemed to be unimportant. In some of these systems, areas in a frame of the video signal that do not contain any change are often excluded from further processing. For example, in an exemplary video conferencing system, background features that are static are often excluded from being stored for each and every frame and only those pixels that indicate a change, such as from movement, are translated and stored. In this manner, the full allotted data amount may be allocated to those areas in which a change is occurring. Noise or graininess may be interpreted as movement and, therefore, the full data amount may be misallocated to areas of low interest, e.g., background details.

### SUMMARY

This section provides a general summary of the disclosure, and is not a comprehensive disclosure of its full scope or all of its features.

In various embodiments of the present disclosure, a method of processing video is disclosed. The method comprises receiving a stream of video and video data from a video capture device. The video data may comprise operating characteristics of the video capture device. The stream of video is analyzed to determine its content characteristics, which are then grouped with the operating characteristics into a plurality of phases. For each of the plurality of phases, the video stream is processed based on the content characteristics and operating characteristics, wherein the phases are performed in an order of preference.

In various additional embodiments of the present disclosure, a system for processing video is disclosed. The system comprises a video capture device and a control module that receives a stream of video and video data from the video capture device. The video data may comprise the operating characteristics of the video capture device. The control module analyzes the stream of video to determine its content characteristics and groups the content characteristics and operating characteristics into a plurality of phases. For each of the plurality of phases, the control module processes the stream of video based on the content characteristics and operating characteristics, wherein the phases are performed in an order of preference.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic block diagram of an exemplary video system according to various embodiments of the present disclosure;

FIG. 2 is a flow chart illustrating an exemplary method of video processing according to various embodiments of the present disclosure; and

FIG. 3 is an image from a video signal to be processed by a system and method according to various embodiments of the present disclosure.

Corresponding reference numerals indicate corresponding parts throughout the several views of the drawings.

### DETAILED DESCRIPTION

As used herein, the term module may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

Example embodiments will now be described more fully with reference to the accompanying drawings.

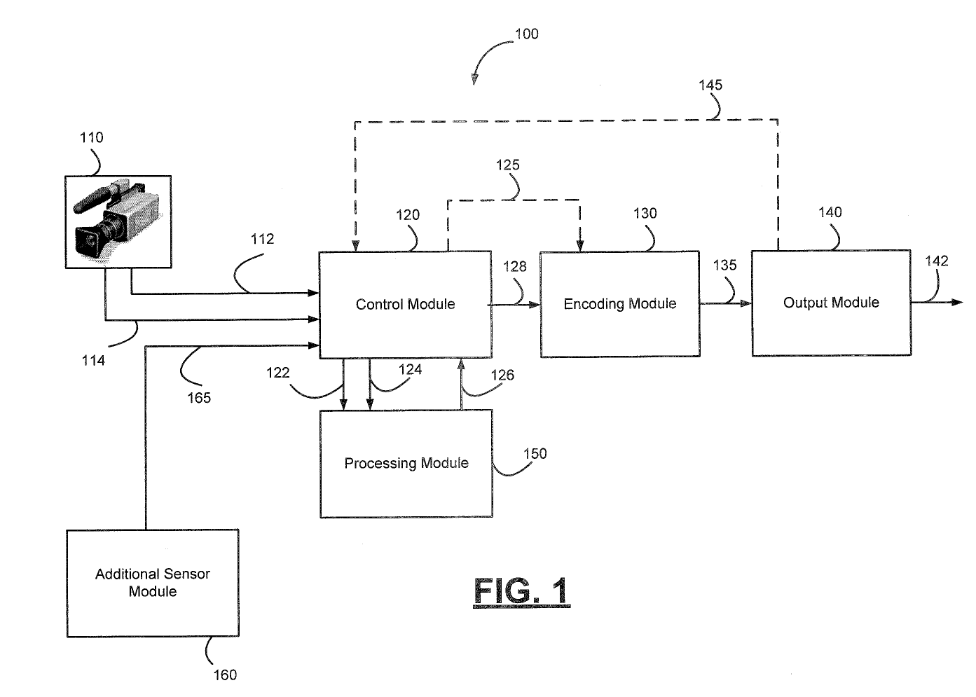

Referring now to FIG. 1, an exemplary video system 100 according to some embodiments of the present disclosure is illustrated. Video system 100 comprises at least one video capture device 110 in communication with a control module 120. Video capture device 110 may be an analog or a digital video camera capable of outputting a video signal 112 and a data signal 114. Video signal 112 can correspond to a stream of video captured by the video capture device and may be in analog, digital or combination format. Video signal 112 can be output as a series of frames that may be individually, or as a group, manipulated by the control module, as described more fully below.

The data signal 114 output from video capture device 110 may include a plurality of operating characteristics of the video capture device. These operating characteristics may include, but are not limited to, lighting levels, shutter speed of camera, the input bit rate, the pan/tilt/zoom motion indicator, internal compression settings and/or frame rate of the video capture device. These operating characteristics relate to the video capture device 110 and its performance.

Video system 100 may further include an additional sensor module 160. The additional sensor module may include one or more sensors other than the video capture device 110. These additional sensors may include infrared devices, heat detection devices, motion detection devices, audio detection devices, security system outputs, for example, door sensors or access control sensors, point of sale devices or any other input related to the video signal 112 that may be detected by a different system. The additional sensor module 160 will output an additional sensor signal 165 that may be a plurality of individual signals from individual sensors or one signal from a group of additional sensors.

Control module 120 of video system 100 receives as its inputs the video signal 112 and data signal 114 from the video capture device 110, as well as the additional sensor signal 165. The control module 120 analyzes the video signal 112 to determine the content of the video signal. Control module 120 may analyze the video signal 112 one frame at a time, groups of frames at one time, frame-by-frame with aspects of preceding or subsequent frames considered, or a combination thereof. In its most basic embodiment, control module 120 analyzes the video signal 112 to determine which content characteristics of the video signal should be deemed important or of interest to a user and, therefore, maintained in the representation of the video signal to be stored. The video signal 112 content characteristics may include, but are not limited to, the pre-compression quality of the video signal, the image quality of the signal, a noise level, the lighting conditions, whether a scene change has occurred, a jitter/shakiness of the image, the image complexity, detection of motion or motion levels in the signal, object detection, behavior detection, pattern matching, and/or pattern recognition. One or more of the content characteristics may be utilized by control module 120 to determine the processing of the video signal 112 to be performed by the processing module 150, as described below.

The control module 120 outputs a control signal 122 and video signal 124 to the processing module 150. The control signal 122 provides the instructions to processing module 150 to process the video signal 124. The processing module 150 may perform a number of processing cycles (or “phases”) on the video signal 124, including, filtering, enhancing, noise reduction, etc. as described more fully below. Processing module 150 will then output modified video signal 126 to control module 120. The control module 120 will control the processing module 150 to process the video signal 124 in numerous stages or phases. Thus, modified video signal 126 may be analyzed by control module 120 and resent to processing module 150 as video signal 124 with a new set of control signals 122. Depending on the number of phases, a frame of video signal 112 may be sent and resent by control module 120 to processing module 150 numerous times before, ultimately, being output as processed video signal 128. Processed video signal 128 comprises the video signal 112 that has been modified as dictated by control module 120 and is ready to be encoded by encoding module 130. It should be apparent that control module 120 and processing module 150 may be combined into one module that performs both tasks.

Encoding module 130 encodes the processed video signal 128 in a compressed format. For example, encoding module 130 may encode the process video signal 128 in any number of commonly used video compression formats, including mpeg (such as mpeg-2, mpeg-4, and H.264), motion jpeg, windows media, and others. Some of these encoding formats may have multiple modes that vary the output data rate. For example, variable bit rate, or quality based compression, will use a varying amount of data as needed, depending on the detail and motion in the video to be compressed. Another mode of compression, known as constant bit rate, allows a user to configure the encoding module 130 to output a specific amount of data per video frame, thus allowing the encoding module 130 to preserve the quality of the process video signal. Control module 120 may provide an encoding control signal 125 to the encoding module 130 to control the compression of processing video signal 128. For example, control module 120 may change the amount of data to output in a constant bit rate mode for encoding module 130 in cases where movement is detected in the video signal. Additionally, or in the alternative, control module 120 may switch the compression format of encoding module 130 depending on the content characteristics of the video stream. Examples of settings of encoding module 130 that may be controlled by control module 120 include, but are not limited to, control codec, type of encoder used, variable vs. constant bit rate, quantization settings, quality level, bitrate and codec complexity.

Encoding module 130 will output a compressed video signal 135 to output module 140. Output module 140 may provide a qualitative analysis of the compressed video signal 135. This analysis may be objective, such as by comparing the compressed video signal 135 to the video signal 112 by mechanical means, or subjective, for example by providing the ability of the user of video system 100 to rank the quality of the compressed video signal 135. Output module 140 may then output a feedback signal 145 to control module 120, which allows control module 120 to further enhance the processing of video signal 112. The compressed video signal 135 is then output from output module 140 as output video signal 142. Output video signal 142 may be stored, for example, on a digital storage device.

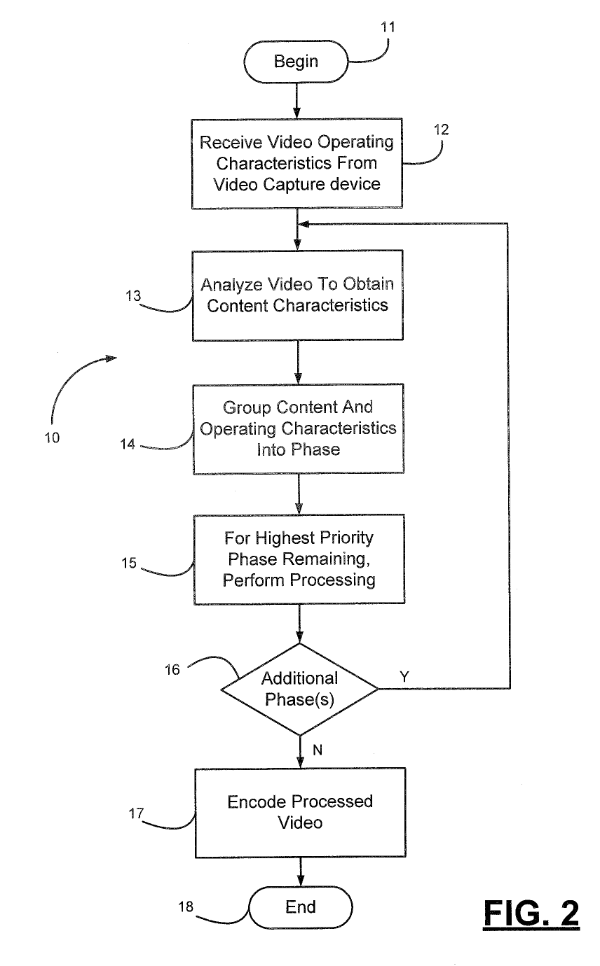

Referring now to FIG. 2, a flow chart illustrating an exemplary method of video processing according to various embodiments of the present disclosure is illustrated. The method 10 begins at step 11. At step 12, the control module receives a video signal and data signal from the video capture device. At step 13, the video is analyzed to determine its content characteristics. The content characteristics comprise information relating to the video signal itself. Content characteristics may include, but are not limited to, the pre-compression quality of the video signal, the image quality, a noise level, information relating to the lighting conditions, an indication of a scene change, the jitter or shakiness of the motion capture device determined from the video signal, the image complexity, motion detection aspects or levels, object and/or behavior detection, and pattern matching or recognition. Each of these content characteristics is determined from the video signal at step 13 and stored for future use according to the method 10.

At step 14, the control module groups the content characteristics and operating characteristics received from step 12 into a plurality of phases. These phases are determined, for example, by grouping and weighting the various content and operating characteristics determined previously. For example, the content characteristics may indicate that there is jitter or shakiness in the video signal. Jitter or shakiness may correlate with a phase of jitter reduction, which may include cropping the video signal. It can be appreciated that this cropping function is best performed before other processing functions occur. For example, cropping of the video signal may be desirable to take place before an enhancement filter is utilized such that processing time and storage is not utilized for information that will be discarded in a later cropping phase.

At step 15, the highest priority phase that has not been performed begins processing the video signal. For example, as stated above, the phase related to jitter or shakiness of the video signal may indicate a cropping process which is then performed. Once the phase processing has occurred, a determination of whether there are additional phases to be performed is made at step 16. If there are remaining phases, the method 10 returns to step 13 which analyzes the now processed video signal to obtain and/or update the content characteristics. It may be appreciated that step 13 may be performed to merely update the content characteristics previously determined in the earlier iterations. The method 10 returns to step 14 which groups the content and operation characteristics into the remaining phases. It should be appreciated that phases that have already been performed for the specific video frame of interest will not be repeated. The method 10 then dictates that the highest priority phase remaining performs processing at step 15. Once all of the phases are performed and there are no additional phases, determined at step 16, the process video is encoded at step 17. The method ends at step 18.

Within a phase, each of the operating characteristics and content characteristics is analyzed. Each of these characteristics may correspond directly to a specific processing step, for example, a content characteristic of high noise may correspond directly to a noise filtering process. Additionally, groupings of characteristics may be related to processing steps, for example, a content characteristic indicating shakiness (or high amounts of movement within a frame) grouped with an operating characteristic that indicates the video capture device is not moving, tilting or panning may correspond directly to a jitter reduction filter.

In some of the embodiments of the present disclosure, the operating and content characteristics are grouped by producing a weight that is stored in a process table. In various embodiments, other characteristics from additional sensors, as described above, may be included in the grouping and weighting. The process table may include all of the potential processes that can be performed by the system. Each of the characteristics may be assigned weights corresponding to one or more processes. When the characteristics are analyzed, the weights corresponding thereto may be stored in the process table. For example, if a low-light content characteristic is detected, weight may be added to one or more processes, such as a noise filter and/or a backlighting/fill lighting filter. Each characteristic in the same phase may add or subtract weights from the process table.

Each characteristic may be cross referenced in the process table with one or more processes that are affected by it. For example, an input from an infrared sensor would indicate something of general importance, therefore weight may be added to processes that up-sample the resolution, sharpen the image data, or release a limit on the frame rate that was in effect because of past inactivity. If the operating characteristics of the video capture device indicate that the camera is in motion, weight may be removed from a noise reduction process, which is less effective when the full frame is in motion, and added to a process for reducing motion blur. The swiping of a badge at a door may be configured to add weight for importance to a specified region of the frame that encompasses where an individual would likely be standing, allowing enhancement in that specific area.

Upon reaching a predetermined weight level in the process table, the control module 120 may instruct the processing module 150 to perform a process on the video signal. In this manner, inputs and processes can be configured as plug-ins that are easily added or removed from the system. The weight(s) assigned to a characteristic may change as the control module 120 learns, e.g., from feedback signal 145. The control module 120 may adjust a weight for whether or not a process is performed, or specific settings within a process. It can be appreciated that each of the processes may have specific settings that affect the level of processing in the process. A simple example of settings for a processing phase is a low or high level of noise reduction.

At the end of a phase, the cumulative process table values may be analyzed by the control module to verify that the processes to be performed are “compatible” with each other. In some cases one process might work better in conjunction with another, or might be mutually exclusive with another process. An example of incompatible processes is a downsampling resolution process, which reduces the amount of data in the video signal, and an enhancement process. Once determining the processes to be performed, the control module 120 controls the processing module 150 to process the video signal in the manner dictated according to an order of preference, discussed below. The video signal is modified according to these processes before moving to the next phase.

The phases are ordered for best performance. The order of preference for the phases, and even the processes to be performed within a phase, may be preset by the designer of the system and/or configurable by a user. Additionally, the system may automatically adjust the order of preference based on a quality measurement process, as described more fully below.

The order of preference is utilized to ensure that the system operates efficiently, while maintaining an acceptable level of detail in the video. It should be appreciated that it is desirable to perform certain processing steps before other processing steps. For example, a resolution re-sampler or cropping process would typically make sense in a first phase, as would a stabilization process, as each of these processes fundamentally alter the image size or rate, and may remove detail that doesn't need to be processed later, saving processing cycles. An additional example of why an order of preference is desirable is as follows. If a sharpen process is used before a different process, such as a noise reduction process, the video details that are enhanced by the sharpen process may then be obscured by the later noise reduction process. Therefore, a noise reduction process may be given preference over a sharpen process in the order of preference. Processes in the same phase may reordered as needed or desired by the algorithm, although processes always happen after the characteristics are analyzed in the same phase.

In some embodiments of the present disclosure, the processes may be grouped into three general phases: pre-filters that fundamentally change the video; filters that perform general processes to the whole video; and processes that often are targeted to certain areas of the video, or would be adversely affected by having other modifications after them, which are generally referred to as enhancements. Examples of pre-filters include, but are not limited to, multiple frame integration, stabilization, color space transformation and upsampling/downsampling of resolution. Examples of filters that perform general processes to the whole video include, but are not limited to, inter-frame noise reduction, temporal noise reduction, de-blocking, analog artifact reduction and de-interlacing. Examples of enhancements include, but are not limited to, sharpen processes, sub-pixel enhancement, smoothing, de-emphasis, motion reduction, contrast, fill lighting and color optimization.

An exemplary system and method of processing a video signal according to various embodiments of the present invention is described below. In this example, the control module 120 analyzes the video signal to determine three content characteristics, specifically (1) motion in the frame, (2) graininess and (3) low light. The video capture device 110 outputs only one operating characteristic: whether or not it is in a zoom condition for that frame. In this system, an infrared (IR) sensor is further configured to output a sensor signal to the control module 120 that indicates whether or not an infrared source, e.g., a person, is within the video frame. In this example, there are three phases of video processing that may be performed by the processing module 150. In the first or pre-filtering phase, a stabilization filter may be used. In the second or general filtering phase, a noise filter may be used. In the final or enhancement phase, a sharpen process may be used on the signal.

The control module 120 groups the additional sensor signal, operating characteristics and content characteristics into one or more of the three phases. For the first phase (stabilization), the control module 120 utilizes the zoom condition and motion in the frame characteristics. A high level of motion in the frame may indicate jitter in the video capture device 110, which is preferably removed before other processing is performed. The zoom condition is utilized as a limiting factor on the motion characteristic because, if the video capture device is zooming during a frame, the control module 120 will perceive a large amount of movement in the video signal due solely to the zoom. For the second phase (noise reduction), the control module 120 utilizes the graininess, low light and motion in the frame characteristics, all of which may be indicative of a noisy signal. For the last phase (enhancement), the control module 120 utilizes the IR detection and motion in the frame characteristics, which may be indicative of an object of interest in the frame.

Upon grouping the characteristics as described above, the control module 120 may then create a process table based on these characteristics. An exemplary process table is shown in Table 1 below. In Table 1, the operating and content characteristics, as well as additional sensor signals in the rows are cross-referenced with the phases to which the relate in the columns. The weights corresponding to each characteristic by process may be preset by a designer of the system, and/or configurable by a user. Additionally, the system may automatically adjust the weights based on a quality measurement process, as described more fully below.

TABLE 1

| | 1^{st} Phase | 2^{nd} Phase | 3^{rd} Phase |
|---|---|---|---|
| | (stabilization) | (noise reduction) | (sharpen) |
| Zoom | −1 | | |
| Motion | 4 | −1 | 4 |
| Graininess | | 4 | |
| Low Light | | 4 | |
| IR detected | | | 6 |
| Totals | 3 | 7 | 10 |

The “Totals” row is the sum of the weights assigned in the interior cells based on the determined characteristics. For example, if a relatively high level of motion is detected in the video signal, a weight of 4 will be added to the stabilization and sharpen phase, indicating that the video signal may need to be stabilized and also may be of high interest. Conversely, a high level of motion may be a negative for the noise reduction process, as the system would not want to remove detail perceived as noise, so a weight of −1 is applied to this phase. A weight of −1 is also applied in the stabilization phase because the video capture device is in a zoom process, thus reducing the desirability of stabilization. Characteristics that are not relevant for a specific phase are not entered into the process table for that phase.

The Totals of the weights for each phase may be used to determine whether or not a process is to be performed. For example, the total weight for a phase may be compared with a threshold; a weight equal to or greater than the threshold will dictate that the process should be performed. In systems where specific settings of a process may be controlled, as described above, multiple thresholds may be used. For example, in noise reduction, a total weight less than 3 may correlate with no noise filtering will be performed, a total weight equal to between 3 and 7, inclusive, may correlate with low noise filtering, while a total weight of 8 and above will indicate a high level of noise filtering to be performed.

Many processes can be controlled to the level of regions of the frame of the video signal. This may be performed by assigning weights in a process table by region such that areas of interest, e.g., a person's face or a license plate, in the video signal are given the greatest detail. Alternatively, or in addition to the region weighting described above, regions of interest in the video signal may be excluded from certain processing steps. For example, it may be desirable to apply a noise filter to areas or regions of a frame such that background noise that is not important to the content of the video signal may be removed. A noise filter applied to the entire frame, however, may remove detail in areas or content of interest to a user. Therefore, the control module may control the processing module such that areas of interest are weighted by region, for example, based on a detection process that finds faces or moving objects, and background noise can be removed from regions of low interest.

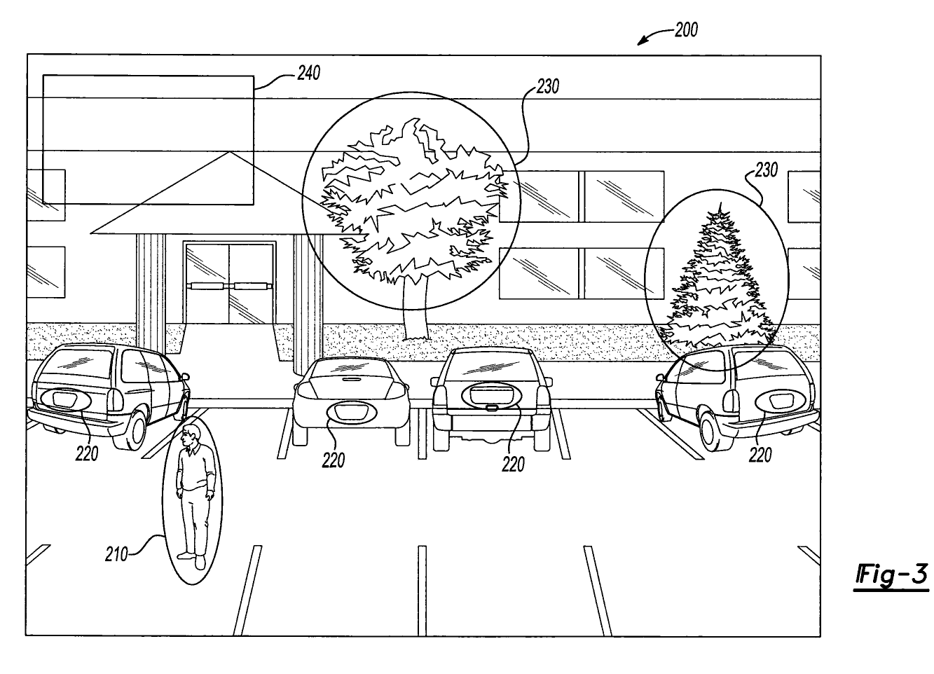

Referring now to FIG. 3, a representation of a frame of a video signal is presented. The frame 200 includes regions or areas corresponding to a person 210, a plurality of license plates 220 on parked vehicles, and trees 230. The control module may determine these areas in various ways. For example, person 210 may be determined by motion detection, object detection and/or infrared sensor, and License plates 220 and trees 230 may be determined by pattern recognition. It should be appreciated that additional regions may be defined (for example, static background area 240), and other detectors and detection methods may be used to determine these regions (for example, the absence of movement in background region 240 for a predetermined time period). Based on these defined regions, control module 120 may add or remove weight from certain processes, as described above.

In some embodiments, weights in the process table may be maintained and/or averaged across multiple frames of the video signal in order to provide a temporal effect that can further improve processing. With the noise filter example, areas that had motion and were excluded from the noise reduction process may have their negative weighting averaged as additional frames are processed, so an area of the frame that recently had motion would be less likely to receive noise reduction processing. In this example, ghosting or shadowing effects, where objects are imprecisely detected from their background or blend in with surroundings, are reduced. As processes are performed on a video signal, additional or altered data may be generated, e.g., updated content characteristics of the processed video signal. This data may utilized by the control module to control future phases of the current frame, or with future frames.

At the end of the last phase, a quality measurement process may be performed. The quality measurement process does not directly modify the frame data, but provides feedback that may be used for processing future frames. The quality measurement process may be performed by a neural net or other artificial intelligence routine. This process would allow the control module 120 to learn which combination of processes achieves the best performance based on video signals from varying subject matter and processes.

The control module 120 may also vary certain aspects of the performance of the processing module 150 that are not dictated by the order of preference. For example, the order of processes in the same phase, or specific settings in a process that do not have a preferred value, may be varied to tune the system for best performance. This tuning process may be based on the quality measurement process described above, in which aspects that improve quality of the processing as a whole are maintained and/or aspects that lower the quality are deleted.

In some embodiments, user interaction may be employed in the processing of the video signal. For example, an end user may be capable of selecting areas of the image that are important or unimportant, thus adding weight to specific processes. Additionally, a user may provide feedback on the quality of the video signal output in comparison to the original, which may be used as an input to the control module.

In some embodiments, the characteristics may be utilized to further improve the operation of video system 100. For example, if a light sensor or the video signal indicates a low-light condition, the control module 120 may act to alleviate this condition by, e.g., decreasing the shutter speed of the video capture device providing the video, increasing the light intake, improving the image exposure and/or operating to turn on external lighting features.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A method of processing video, comprising:
receiving a stream of video from a video capture device;
receiving video data corresponding to the stream of video, the video data comprising operating characteristics of the video capture device;
analyzing the stream of video to determine content characteristics of the stream of video;
grouping the content characteristics and operating characteristics into a plurality of phases; and
for each of the plurality of phases, processing the stream of video based on the content characteristics and operating characteristics, wherein the plurality of phases are performed based on an order of preference.

2. The method of claim 1, further comprising receiving a sensor signal from at least one sensor, wherein the processing the stream of video is further based on the sensor signal.

3. The method of claim 2, wherein the at least one sensor comprises a light sensor, an infrared sensor, a motion detector, an audio detection device, a security system, an access control device, or a point of sale device.

4. The method of claim 1, wherein the plurality of phases comprises a pre-filter phase, a filtering phase and an enhancement phase.

5. The method of claim 1, further comprising defining at least one region within the stream of video and processing the at least one region separately from the stream of video.

6. The method of claim 5, wherein the defining at least one region is based on the content characteristics.

7. The method of claim 1, further comprising revising the order of preference based on a measurement of quality of the processed stream of video.

8. The method of claim 1, further comprising encoding the processed stream of video based on the content characteristics and operating characteristics.

9. The method of claim 8, further comprising defining at least one region within the stream of video and processing the at least one region separately from the stream of video.

10. The method of claim 9, wherein the defining at least one region is based on the content characteristics.

11. A system for processing video, comprising:
a video capture device; and
a control module that receives a stream of video and video data from the video capture device, the video data comprising operating characteristics of the video capture device, wherein the control module:
analyzes the stream of video to determine content characteristics of the stream of video;
groups the content characteristics and operating characteristics into a plurality of phases; and
for each of the plurality of phases, processes the stream of video based on the content characteristics and operating characteristics, wherein the plurality of phases are performed based on an order of preference.

12. The system of claim 11, further comprising at least one sensor, wherein the processing of the stream of video by the control module is further based on a sensor signal from the at least one sensor.

13. The system of claim 12, wherein the at least one sensor comprises a light sensor, an infrared sensor, a motion detector, an audio detection device, a security system, an access control device, or a point of sale device.

14. The system of claim 11, wherein the plurality of phases comprises a pre-filter phase, a filtering phase and an enhancement phase.

15. The system of claim 11, wherein the control module defines at least one region within the stream of video and processes the at least one region separately from the stream of video.

16. The system of claim 15, wherein the control module defines at least one region within the stream of video based on the content characteristics.

17. The system of claim 11, wherein the control module determines a measurement of quality of the processed stream of video and revises the order of preference based on the measurement of quality.

18. The system of claim 11, further comprising an encoding module that encodes the processed stream of video based on the content characteristics and operating characteristics.

19. The system of claim 18, wherein the control module defines at least one region within the stream of video and processes the at least one region separately from the stream of video.

20. The system of claim 19, wherein the control module defines at least one region within the stream of video based on the content characteristics.
